(19) United States
(12) Patent Application Publication
(10) Pub. No.: US 2021/0372640 A1
(43) Pub. Date: Dec. 2, 2021

(54) HUMIDIFICATION AND AIR CLEANING APPARATUS

(71) Applicant: LG ELECTRONICS INC., Seoul (KR)

(72) Inventors: Seungdeok Yang, Seoul (KR); Jaehyuk Jung, Seoul (KR); Taehun Lee, Seoul (KR); Seokho Choi, Seoul (KR)

(21) Appl. No.: 17/328,004

(22) Filed: May 24, 2021

(30) Foreign Application Priority Data
May 26, 2020 (KR) 10-2020-0063068

(51) Int. Cl. F24F 8/10; F24F 11/00; F24F 11/56; B01D 46/44; B01D 46/00

(52) U.S. Cl. CPC F24F 8/10; F24F 11/0008; F24F 2006/008; B01D 46/44; B01D 46/0027; F24F 11/56

(57) ABSTRACT

A humidification and air cleaning apparatus is provided that may include a lower base, a lower housing, a plurality of legs, a leg wall, and an input assembly. The lower base may be supported by an installation surface. The lower housing may be spaced apart upwardly from the lower base and form a suction gap by being spaced apart from the lower base. The plurality of legs may be disposed on at least one of the lower base or a lower housing. The plurality of legs may support the lower housing. The leg wall may connect two adjacent legs to each other. The input assembly may be disposed at the lower housing. The input assembly may protrude toward the suction gap. The input assembly may receive a wireless signal. The plurality of legs may include a first leg and a second leg adjacent to each other. The input assembly may be disposed outside of the leg wall. As an input assembly receiving a voice signal is exposed to the outside, a user's voice may be effectively recognized. Further, as the leg wall is disposed between the input assembly and the lower housing inlet, it is possible to suppress propagation of operating noise generated by a blowing unit to the input assembly.

### CROSS-REFERENCE TO RELATED APPLICATION(S)

This application claims the priority benefit of Korean Patent Application No. 10-2020-0063068, filed in Korea on May 26, 2020 in the Korean Intellectual Property Office, the disclosure of which is incorporated herein by reference.

### BACKGROUND

### 1. Field

A humidification and air cleaning apparatus equipped with a voice recognition module is disclosed herein.

### 2. Background

Air conditioners include an air conditioner that controls a temperature of the air, an air purifier that removes foreign substances from the air to maintain cleanliness, a humidifier that provides moisture to the air, and a dehumidifier that removes moisture from the air. Conventional humidifiers are classified into a vibration type that atomizes water from a vibration plate and discharges it into the air, and a natural evaporation type that evaporates naturally from a humidification filter. The natural evaporation humidifier is classified into a disk type humidifier evaporating the water on the surface of the disk by rotating the disk with a drive force, and a humidification filter-type humidifier naturally evaporating the water soaked into the humidification medium in which the air flows.

The main purpose of the conventional humidifier is to humidify the air, and the main purpose of the conventional air purifier is to filter foreign substances in the air. To compensate for this, a humidification cleaning device that simultaneously humidifies and filters air has been developed.

Conventional humidification and cleaning devices are operated by receiving a remote control signal or inputting a user's control signal.

With the development of technology, types of home appliances provided in homes are increasing, and various kinds of additional functions provided in home appliances are increasing. Accordingly, research has been actively conducted to apply artificial intelligence technology to the humidification and cleaning device and to allow the user to control the humidification and cleaning device with voice.

### BRIEF DESCRIPTION OF THE DRAWINGS

Embodiments will be described in detail with reference to the following drawings in which like reference numerals refer to like elements, and wherein:

FIG. 1 is a perspective view of a humidification and air cleaning apparatus according to an embodiment;

FIG. 2 is an exploded perspective view of the humidification and air cleaning apparatus of FIG. 1;

FIG. 3 is an exploded front view of the humidification and air cleaning apparatus of FIG. 1;

FIG. 4 is a cross-sectional view of the humidification and air cleaning apparatus of FIG. 2;

FIG. 5 is a perspective view showing an inside of a lower body shown in FIG. 2;

FIG. 6 is a front view of the lower body of FIG. 5;

FIG. 7 is a left side view of the lower body of FIG. 5;

FIG. 8 is a perspective view of a lower housing shown in FIG. 5;

FIG. 9 is a plan view of the lower housing of FIG. 8;

FIG. 10 is an enlarged view showing surroundings of an input assembly of FIG. 3;

FIG. 11 is a bottom view of the lower housing shown in FIG. 8;

FIG. 12 is a cross-sectional view, taken along line XII-XII′ shown in FIG. 11;

FIG. 13 is a graph in which noise in front of a leg wall is shown;

FIG. 14 is a perspective view showing an inside of an input assembly shown in FIG. 1;

FIG. 15 is a cross-sectional perspective view, taken along line XV-XV′ of FIG. 14;

FIG. 16 is a perspective view of a microphone shown in FIG. 14; and

FIG. 17 is a cross-sectional view, taken along line XVII-XVII′ shown in FIG. 16.

### DETAILED DESCRIPTION

Advantages and features of embodiments, and a method of achieving them will become apparent with reference to embodiments described herein together with the accompanying drawings. However, the embodiments are not limited to the embodiments disclosed herein but may be implemented in a variety of different forms. The embodiments are provided to provide complete disclosure and to fully inform a scope to those who skilled in the art to which the embodiments pertains. The disclosure is only defined by the scope of the claims. The same reference sign refers to the same elements throughout.

Hereinafter, embodiments will be described with reference to the drawings.

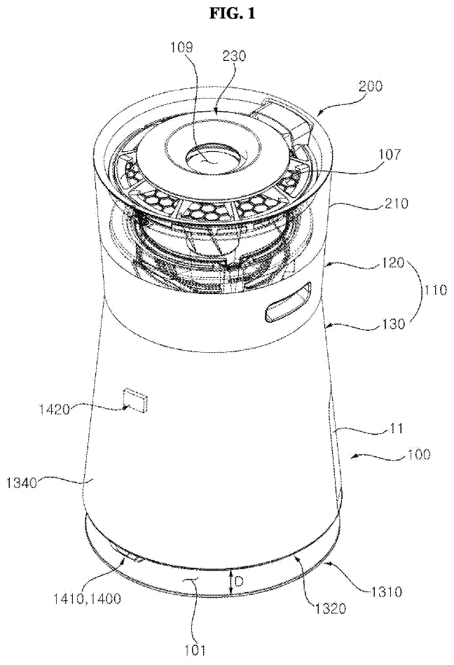

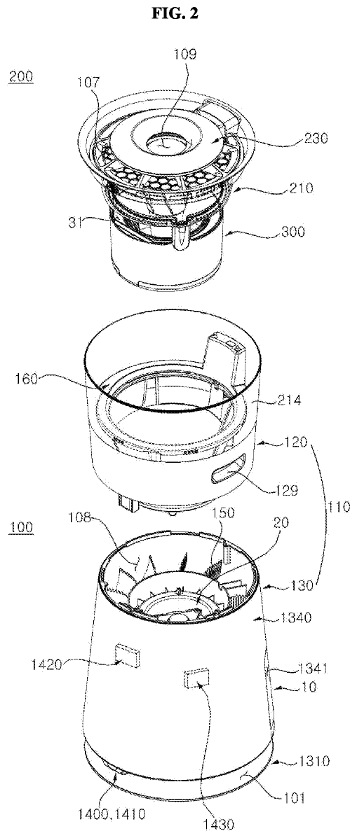

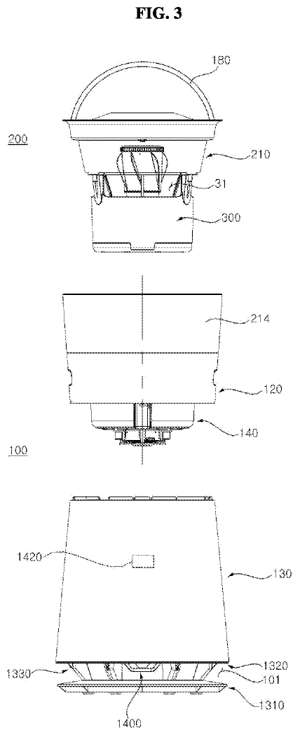

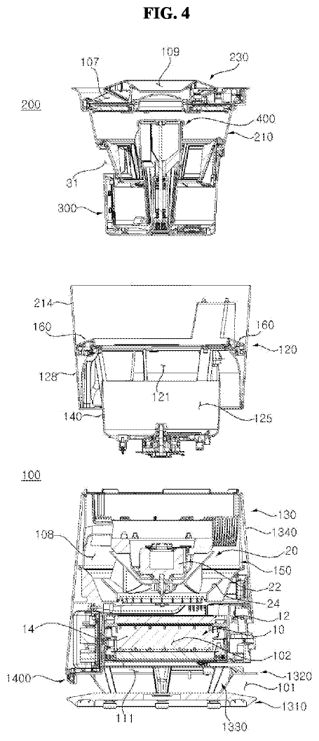

FIG. 1 is a perspective view of a humidification and air cleaning apparatus according to an embodiment. FIG. 2 is an exploded perspective view of the humidification and air cleaning apparatus of FIG. 1. FIG. 3 is an exploded front view of the humidification and air cleaning apparatus of FIG. 1. FIG. 4 is a cross-sectional view of the humidification and air cleaning apparatus of FIG. 2.

Referring to FIG. 1 to FIG. 4, the humidification and air cleaning apparatus according to an embodiment may include an air cleaning module 100 and an air humidification module 200 mounted on an upper side of the air cleaning module 100, and a voice recognition module 1400 may be disposed in the air cleaning module 100.

The air cleaning module 100 suctions and filters external air and provides the filtered air to the air humidification module 200. The air humidification module 200 receives the filtered air and provides moisture to the flowing filtered air, and then discharges the humidified air to the outside.

The air humidification module 200 may include a water tank 300 in which water may be stored. An upper side surface of the water tank 300 may be exposed to the outside. The water tank 300 may form a portion of the air humidification module 200.

When the air humidification module 200 is separated, the water tank 300 may be separable from the air cleaning module 100 together with the air humidification module 200. The air humidification module 200 may be mounted above the air cleaning module 100.

The user may separate the air humidification module 200 from the air cleaning module 100 and clean the separated air humidification module 200. The user may clean an inside of the air cleaning module 100 from which the air humidification module 200 is separated. When the air humidification module 200 is separated, an upper surface of the air cleaning module 100 may be exposed to the user. The air cleaning module 100 may be cleaned after separating a filter assembly 10 described hereinafter.

The user may directly supply water to the water tank 300 while the air humidification module 200 is mounted on the air cleaning module 100. A water supply passage through which water may be supplied from the outside thereof to the water tank 300 may be formed in the air humidification module 200.

The water supply passage may be configured to supply water to the water tank at any time. For example, even when the air humidification module 200 is in operation, water may be supplied through the water supply passage. For example, even when the air humidification module 200 is coupled to the air cleaning module 100, water may be supplied through the water supply passage.

The air cleaning module 100 may include a base body 110. The air cleaning module 100 may include filter assembly 10 disposed on the base body 110 and that filters the air. The air cleaning module 100 may include a blowing unit 20 disposed on the base body 110 and that causes the air to flow.

The air humidification module 200 may include the water tank 300 that stores the water for humidification and separably mounted on the air cleaning module 100. The air humidification module 200 may include a humidification unit 400 disposed in an inside of the water tank 300 and spraying the water of the water tank 300. The air humidification module 200 may include a humidifying medium wetted by the water sprayed from the humidification unit 400 and supplying moisture to the flowing air. The air humidification module 200 may include a visual body 210 coupled to the water tank 300 and formed of a material through which the inside may be viewed. The air humidification module 200 may include a top cover assembly 230 mounted separably on the visual body 210 and on which a discharge flow path 109 through which the air is discharged and a water supply flow path 107 through which water is supplied.

Referring to FIG. 1 to FIG. 4, the air humidification module 200 may supply moisture to the filtered air. The air humidification module 200 may realize a rain view. The air humidification module 200 may spray the water in the water tank 300 and circulate it. The air humidification module 200 may transform water into the small droplets and provide moisture to the filtered air again using scattered droplets. After providing moisture to the filtered air using the scattered droplets, humidification and filtering may be performed again.

The air humidification module 200 may include the water tank 300, the humidification unit 400, the humidifying medium, the visual body 210, the top cover assembly 230, and a handle 180. The handle 180 may be coupled to the visual body 210 and rotate on the visual body 210 and may be accommodated in the visual body 210. The air humidification module 200 may be lifted by the handle 180 with ease and may be separated from the air cleaning module 100.

The water tank 300 may be separably mounted on an upper body assembly 120. The humidification unit 400 may be disposed inside of the water tank 300 and may rotate inside of the water tank 300.

Referring to FIG. 1 to FIG. 4, the air cleaning module 100 may include the base body 110. The air cleaning module 100 may include the filter assembly 10 disposed on the base body 110 and that filters the air. The air cleaning module 100 may include the blowing unit 20 disposed on the base body 110 and that causes the air to flow. The air cleaning module 100 may include the voice recognition module 1400 disposed on the base body 110.

The base body 110 may include the upper body assembly 120, a lower body assembly 130, and a lower base 1310. The lower base 1310 may be positioned on the ground (an installation surface), and the lower body assembly 130 and the upper body assembly 120 may be sequentially arranged above the lower base 1310.

The lower body assembly 130 may be spaced apart from the lower base 1310 and a suction hole 101 may be disposed between the lower base 1310 and the lower body assembly 130. The lower base 1310 and the lower body assembly 130 may be spaced apart in a vertical direction to form a suction gap D. The suction gap D may be formed in an entire 360-degree lateral direction thereof. The air passing through the suction hole 101 may flow into the lower body assembly 130.

The upper body assembly 120 may be stacked on an upper side of the lower body assembly 130, and the upper body assembly 120 and the lower body assembly 130 may be assembled.

The base body 110 may form an outer shape of the air cleaning module 100. The filter assembly 10 and the blowing unit 20 may be disposed inside of the base body 110.

The air flows into the base body 110. The base body 110 may include the lower body assembly 130 forming an outer shape thereof and in which the suction hole 111 is formed on a lower side thereof and accommodating the filter assembly 10 and the blowing unit 20. The base body 110 may include the upper body assembly 120 forming the outer shape and coupled to the upper side of the lower body assembly 130.

Referring to FIG. 1 to FIG. 4, the lower body assembly 130 may include a lower housing 1320 disposed above the lower base 1310 and forming the suction hole 101 by being spaced apart from the lower base 1310. The lower body assembly 130 may include a plurality of legs 1330 disposed between the lower base 1310 and the lower housing 1320 and that supports the lower housing 1320 and separates the lower housing 1320 and the lower base 1310. The lower body assembly 130 may include a lower cover 1340 that surrounds an outside of the lower housing 1320.

The lower base 1310 may support a load of the humidification and air cleaning apparatus. The lower base 1310 may be supported by the ground. Referring to the top view of this embodiment, the lower base 1310 may be formed in a ring or disk shape.

The leg 1330 may have a lower end assembled to the lower base 1310 and an upper end assembled to the lower housing 1320. In this embodiment, the leg 1330 may be manufactured with the lower housing 1320 as one body by, for example, injection molding. Thus, the leg 1330 may be assembled with the lower base 1310.

The plurality of legs 1330 may be disposed between the lower base 1310 and the lower housing 1320. The suction hole 101 may be formed by the plurality of legs 1330. The suction hole 101 may suction the air in a 360-degree direction.

The lower base 1310 and the lower housing 1320 may be vertically spaced to form the suction gap D. The suction hole 101 may be formed by the suction gap D.

A load of the entire structure above the lower housing 1320 may be supported by the plurality of legs 1330.

A bottom of the lower housing 1320 may communicate with the suction hole 101 and may guide the air from the suction hole 101 to the filter assembly 10. In this embodiment, the filter assembly 10 may be assembled to the lower housing 1320 and the filter housing 1200, which will be described hereinafter, may be assembled to the lower housing 1320.

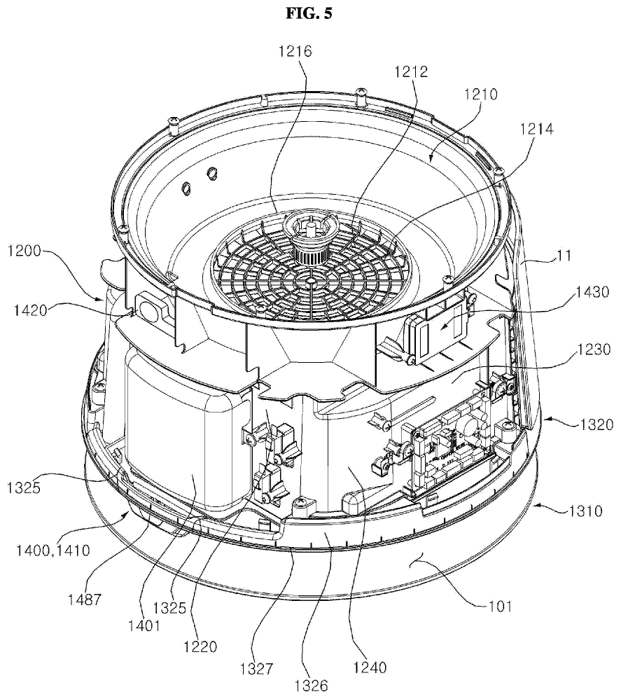

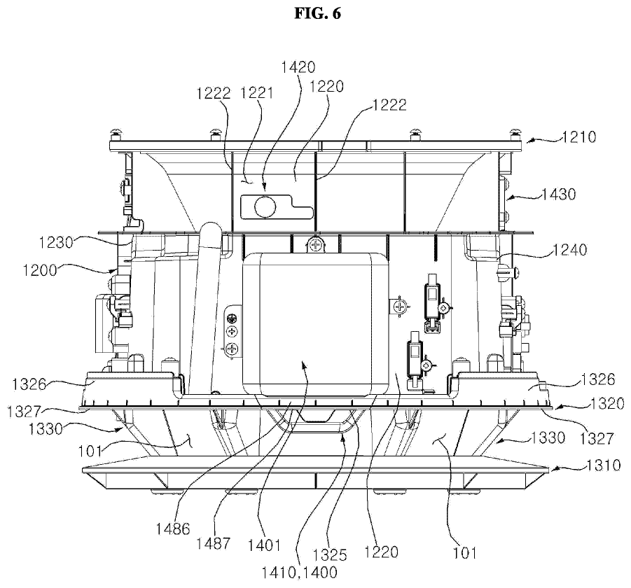

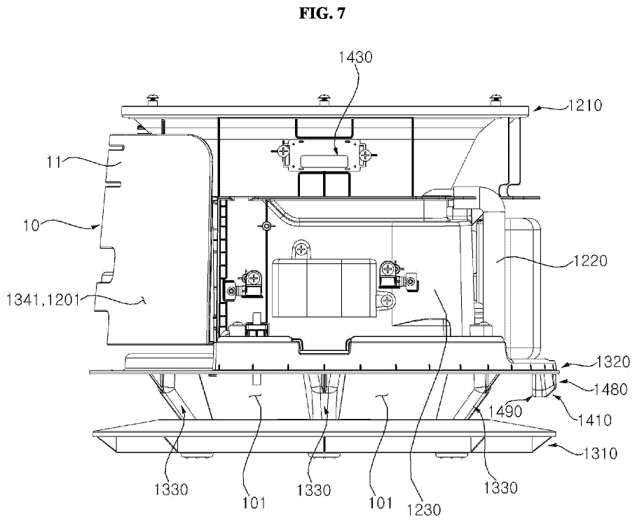

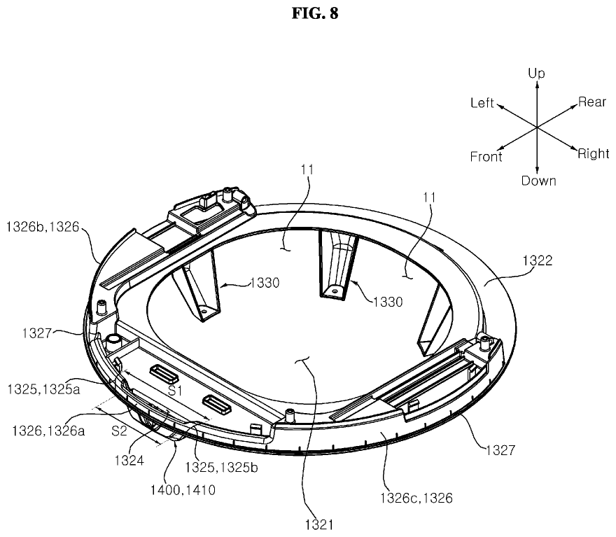

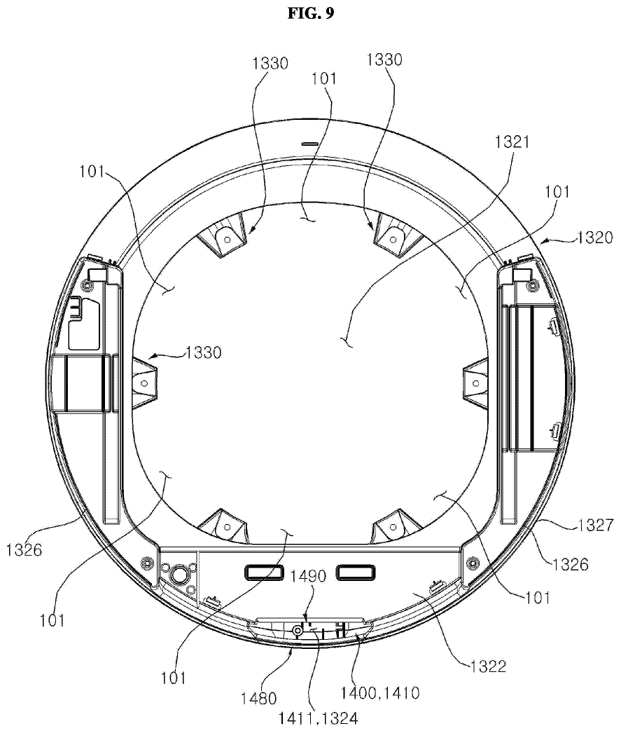

FIG. 5 is a perspective view showing an inside of a lower body shown in FIG. 2. FIG. 6 is a front view of the lower body of FIG. 5. FIG. 7 is a left side view of the lower body of FIG. 5. FIG. 8 is a perspective view of a lower housing shown in FIG. 5. FIG. 9 is a plan view of the lower housing of FIG. 8.

Referring to FIG. 8 and FIG. 9, the lower housing 1320 may include a lower housing body 1322 supported by the legs 1330. The lower housing 1320 may include a lower housing suction hole 1321 that communicates with the suction hole 101 and opened vertically and disposed inside of the lower housing body 1322. The lower housing 1320 may include a voice recognition module installation part or portion 1324 disposed on the lower housing body 1322 and assembled with the voice recognition module 1400. The lower housing 1320 may include a lower cover lateral surface supporting part or portion (support) 1326 disposed on the lower housing body 1322 and supporting the lower cover 1340. The lower housing 1320 may include a lower cover bottom support part or portion (support) 1327 disposed on the lower housing body 1322 and supporting the bottom of the lower cover 1340.

In this embodiment, the lower housing body 1322 is formed in a ring shape when viewed from a top view, and the lower housing suction hole 1321 is formed inside thereof. The lower housing suction hole 1321 passes through the lower housing body 1322 in the vertical direction.

The leg 1330 may be manufactured with the lower housing body 1322 as one body and may protrude downward from the lower housing body 1322. Alternatively, the leg 1330 may be separately manufactured and then assembled to the lower housing body 1322.

A filter housing 1200 may be stacked above the lower housing body 1322. The lower housing body 1322 and the filter housing 1200 may be fastened.

The lower housing body 1322 may be in close contact with a bottom surface of the filter housing 1200. Thus, leakage between the filter housing 1200 and the lower housing body 1322 of air suctioned through the suction hole 101 may be minimized.

The voice recognition module 1400 may be installed inside of the base body 110. In this embodiment, the voice recognition module 1400 is exposed to an outside of the base body 110 to improve probability of recognition.

The voice recognition module installation part 1324 may have an installation structure in which the voice recognition module 1400 may be installed. The voice recognition module installation part 1324 provides a structure for exposing the voice recognition module 1400 to the outside.

The voice recognition module installation part 1324 may be in the form of a hole that penetrates the lower housing body 1322 in the vertical direction. The voice recognition module 1400 may pass through the voice recognition module installation part 1324 formed in a hole shape and may be assembled to the lower housing body 1322.

In this embodiment, the voice recognition module installation part 1324 is formed by opening a portion of the lower housing body 1322, the lower cover lateral surface supporting part 1326, and the lower cover bottom supporting part 1327.

The voice recognition module installation part 1324 may be formed by opening a part or portion of a front side of the lower housing 1320. The voice recognition module installation part 1324 may be formed concavely from a front to a rear side of the lower housing 1320 and form a continuous line with the lower housing 1320 when the voice recognition module 1400 is installed.

The voice recognition module 1400 is assembled by being inserted into the voice recognition module installation part 1324 in a direction from a top to a bottom. The voice recognition module installation part 1324 has a stopper 1325 to form a mutual engagement with the voice recognition module 1400.

In this embodiment, the stopper 1325 may be formed over the lower cover lateral surface supporting part 1326 and the lower cover bottom supporting part 1327. The stopper 1325 may include a first stopper 1325a forming a mutual engagement with a left (first) edge of the voice recognition module 1400, and a second stopper 1325b forming a mutual engagement with a right (second) edge of the voice recognition module 1400.

The voice recognition module 1400 may be disposed between the first stopper 1325a and the second stopper 1325b. A lower side distance S2 may be wider than an upper side distance S1 between the first and second stoppers 1325a, 1325b.

In addition, the voice recognition module installation part 1324 may be disposed on an extension line of the lower cover lateral surface supporting part 1326 and the lower cover bottom supporting part 1327. The lower cover lateral surface supporting part 1326 may protrude upwardly from the lower housing body 1322. The lower cover lateral surface supporting part 1326 may be formed along an outer edge of the lower housing body 1322. The lower cover 1340 may be in close contact with the lower cover lateral surface supporting part 1326.

As the lower housing body 1322 is formed in a plate shape, bending deformation may occur. As the lower cover lateral surface supporting part 1326 protrudes upwardly from the lower housing body 1322, a strength of an outer edge of the lower housing 1320 may be increased.

The voice recognition module installation part 1324 may form a part or portion of the lower cover lateral surface supporting part 1326 and the lower cover bottom supporting part 1327. The lower cover lateral surface supporting part 1326 and the lower cover bottom supporting part 1327 may be formed only on some edges of the lower housing body 1322.

In this embodiment, the lower cover lateral surface supporting part 1326 and the lower cover bottom supporting part 1327 are disposed at a front, and left and right sides, and are not formed at a rear side into which a filter 14 is inserted.

The lower cover lateral surface supporting part 1326 may include a first lower cover supporting part or portion (support) 1326a disposed on a front edge of the lower housing body 1322 and a second lower cover supporting part or portion (support) 1326b disposed on an edge of a left side of the lower housing body 1322, and a third lower cover supporting part or portion (support) 1326c disposed on an edge of a right side of the lower housing body 1322. The lower cover bottom supporting part 1327 may be located on a same plane as the lower housing body 1322. The lower cover bottom supporting part 1327 may protrude from the lower cover lateral surface supporting part 1326 in a horizontal direction.

A lower end of the lower cover 1340 may be supported by an upper side of the lower cover bottom supporting part 1327. In this embodiment, the lower cover bottom supporting part 1327 may protrude radially from a center of the lower housing suction hole 1321.

The lower cover bottom supporting part 1327 may be disposed outside of the lower cover lateral surface supporting part 1326. In this embodiment, the lower cover bottom supporting part 1327 may protrude radially from the lower cover lateral surface supporting part 1326. The lower cover bottom supporting part 1327 may be formed on all of the first lower cover supporting part 1326a, the second lower cover supporting part 1326b, and the third lower cover supporting part 1326c.

As the voice recognition module 1400 forms a continuous surface with a part of the lower housing 1320, some outer surfaces of the voice recognition module 1400 may provide a continuous surface with the lower cover lateral surface supporting part 1326 and the lower cover bottom supporting part 1327. In addition, some of the outer surfaces of the voice recognition module 1400 may provide some functions of the lower cover lateral surface supporting part 1326 and the lower cover bottom supporting part 1327.

Referring to FIG. 1 or FIG. 2, the lower cover 1340 may form an outer surface of the lower body assembly 130. The lower cover 1340 may include a lower cover opening 1341 formed on a side surface of the lower cover 1340. The filter assembly 10 may be inserted in a lateral direction through the lower cover opening 1341.

The lower cover 1340 may be supported by an upper side surface of the lower housing 1320. An inner side surface of the lower cover 1340 may be in close contact with the lower cover lateral surface supporting part 1326, and a lower end may be supported by the lower cover bottom supporting part 1327.

The lower cover 1340 may be fastened and fixed to at least one of the lower housing 1320 or the upper body assembly 120. The lower cover 1340 may have an open upper side and an open lower side. The lower cover 1340 may have a cylindrical shape with the open lower side wider than the open upper side.

The lower cover 1340 may cover and hide the filter assembly 10 and the blowing unit 20 disposed inside of the lower body assembly 130.

In this embodiment, the voice recognition module 1400 may be exposed to an outside of the lower cover 1340. As the voice recognition module 1400 protrudes below the lower housing 1320, it is not covered by the lower cover 1340. The voice recognition module 1400 may protrude downwardly from the lower cover 1340 and be exposed to a user.

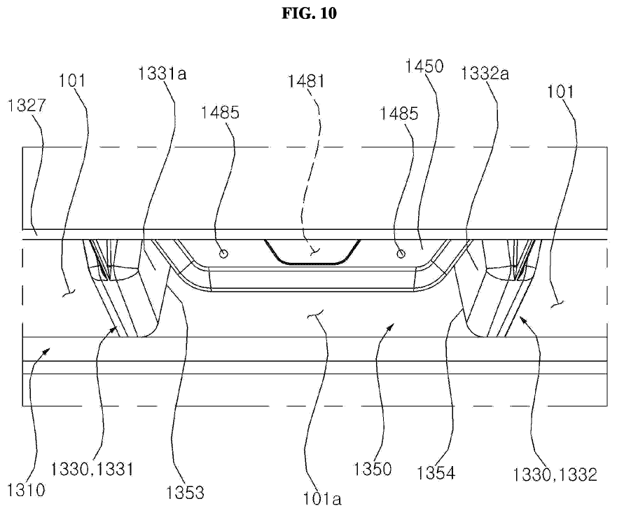

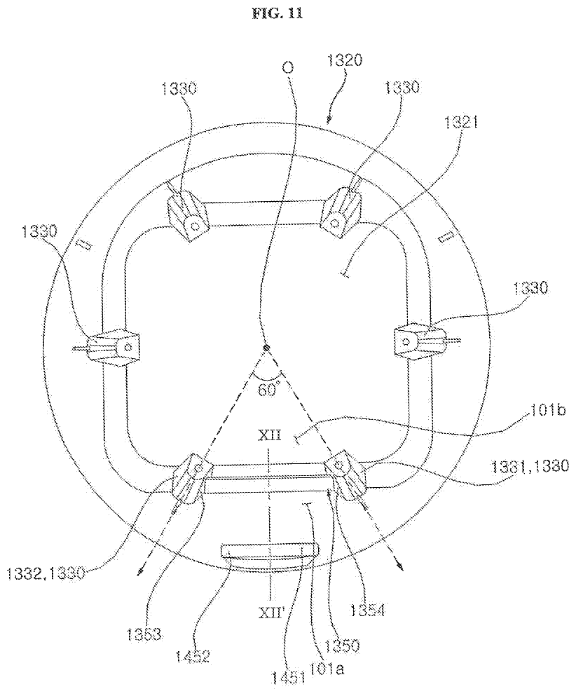

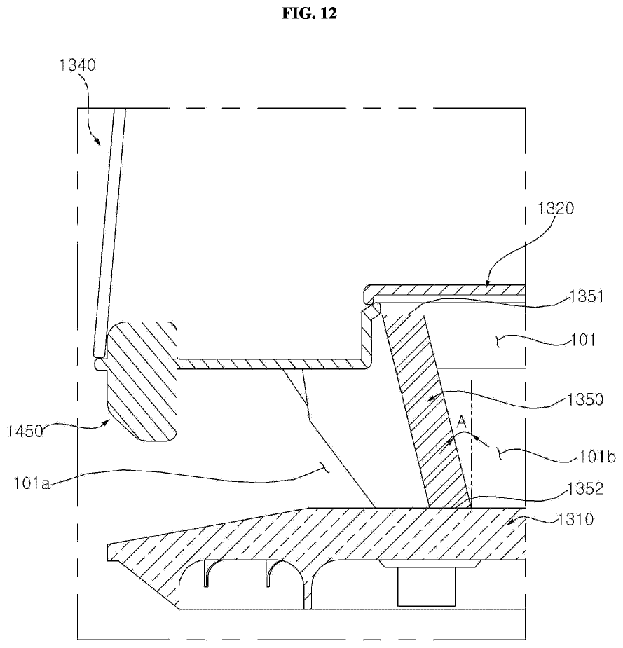

FIG. 10 is an enlarged view showing surroundings of an input assembly of FIG. 3. FIG. 11 is a bottom view of the lower housing shown in FIG. 8. FIG. 12 is a cross-sectional view, taken along line XII-XII′ shown in FIG. 11.

A plurality of the leg 1330 may be provided. Further, referring to FIG. 10 to FIG. 12, a leg wall 1350 that connects two of the plurality of legs 1330 may be provided. In this embodiment, six legs 1330 are provided; however, embodiments are not limited thereto. The plurality of legs 1330 may be disposed radially with respect to a center O of the lower housing 1320, and each leg 1330 may be disposed with an interval of 60 degrees with respect to the center O.

The center O may be an inner core of the lower housing 1320 and may be located on or at a motor shaft of blower motor 22. Each of the legs 1330 may extend toward the center O, and a lower end of each leg 1330 may be closer to the center O than an upper end each leg 1330.

The leg wall 1350 may connect two adjacent legs among the plurality of legs 1330. In this embodiment, the leg wall 1350 is disposed in front. Among the plurality of legs 1330 combined with the leg wall 1350, what is disposed on one (first) side (the left in this embodiment) is a first leg 1331 and what is disposed on the other (second) side (right side in this embodiment) is a second leg 1332.

An upper end 1351 of the leg wall 1350 may be coupled to the lower housing 1320. A lower end 1352 may be coupled to the lower base 1310. A left (first) end 1353 may be coupled to the first leg 1331. A right (second) end 1354 may be coupled to the second leg 1332.

The leg wall 1350 may completely seal the first leg 1331 and the second leg 1332. A front of the leg wall 1350 may be disposed outside of the suction hole 101, and a rear surface may be disposed on or at a side of the suction hole 101.

A lower end of the lower housing 1320 may be disposed higher than the lower end 1352 of the leg wall 1350. The lower end of the lower housing 1320 may be disposed lower than the upper end 1351 of the leg 1350.

In addition, the suction hole 101 may be divided into an outer space 101a and an inner space 101b by the leg wall 1350. An input assembly 1410 described hereinafter may be disposed in the outer space 101a. The input assembly 1410 may receive a wireless signal. For example, the input assembly 1410 may receive a user's voice signal or a remote control signal. The input assembly 1410 may be spaced apart from the leg wall 1350, disposed in front of the leg wall 1350, and in the outer space 101a.

The leg wall 1350 may be inclined with respect to the vertical direction, and in this embodiment, the upper end 1351 may be inclined to be positioned in front of the lower end 1352. In this embodiment, an inclination angle A of the leg wall 1350 is 15 degrees; however, embodiments are not limited thereto.

The leg wall 1350 may be formed in a curved surface with the center O as a center of curvature. In this embodiment, the leg wall 1350 has a flat surface and is disposed to face an input housing 1450 described hereinafter.

As the leg wall 1350 is disposed between the lower housing suction hole 1321 and the input assembly 1410, noise propagating from propagating to the input assembly 1410 through the lower housing suction hole 1321 may be suppressed. For example, the noise through the lower housing suction hole 1321 may be a sound of water caused by operation of the humidification unit 400, or operation noise caused by operation of the blower motor 22, for example.

In addition, the user's voice may be reflected by a front surface of the leg wall 1350, thereby improving a possibility of recognition. In the frontal view, the outer space 101a may be concave backwardly, thereby the user's voice may be collected toward the input assembly 1410.

Referring to FIG. 4 to FIG. 7, the filter assembly 10 may be assembled detachably with the base body 110. The filter assembly 10 may include a filter flow path 102 and filter outside air. The filter assembly 10 may have a structure that can be detached from the base body 110 in the horizontal direction. The filter assembly 10 may be disposed to cross a flow direction of the air flowing in the vertical direction. The filter assembly 10 may slide in the horizontal direction and filter air flowing upwardly. The filter assembly 10 may be disposed horizontally and form the filter flow path 102 in the vertical direction.

The filter assembly 10 may include the filter housing 1200 disposed inside of the lower body assembly 130 and forming the filter flow path 102. The filter assembly 10 may include the filter 14 inserted into the filter housing 1200 passing through the side of the lower body assembly 130 and detachably coupled to the filter housing 1200 and filtering the flowing air. The filter assembly 10 may include a filter cover 11 coupled to the filter 14 and closing the lower cover opening 1341 of the lower body assembly 130. The filter assembly 10 may include a housing top cover 1210 that covers a top surface of the filter housing 1200 and guides air inside the filter housing 1200 into the blowing unit 20.

A lower side of the filter housing 1200 may communicate with the suction hole 101. An upper side of the filter housing 1200 may communicate with a blowing flow path 108. The filter flow path 102 may be formed in the filter housing 1200. The filter 14 may be separably inserted into the filter housing 1200.

One side of the filter housing 1200 may be open in a direction crossing the filter flow path 102. The filter 14 may be detachably coupled to a filter housing opening 1201 of the filter housing 1200. The filter housing opening 1201 of the filter housing 1200 may extend in a lateral direction. The filter housing opening 1201 of the filter housing 1200 may be disposed toward the lower cover opening 1341 of the lower body assembly 130.

The filter 14 may be inserted into the filter housing 1200 through the lower cover opening 1341 of the lower body assembly 130. The filter 14 may intersect with the filter flow path 102, and filter the air passing through the filter flow path 102. The filter 14 may be an electric dust collecting filter that collects foreign substances in air by electrifying the foreign substances with applied power. The filter 14 may be formed of a material that collects foreign substances in air through a filter medium. The filter 14 may have various structures. Embodiments are not limited by a filtering method of the filter 14 or a filter medium of the filter 14.

The filter flow path 102 may be arranged in a same direction as a main flow direction of the humidification and air cleaning apparatus. In this embodiment, the filter flow path 102 is arranged in the vertical direction and causes the air to flow in a direction opposite to gravity. That is, the main flow direction of the humidification and air cleaning apparatus has a path from a lower side to a upper side.

The filter housing 1200 may be in the lower cover 1340. A top surface, a bottom surface, and a part or portion of a side of the filter housing 1200 may be opened. The lower housing 1320 may close a part or portion of a lower side of the filter housing 1200 and be assembled with the filter housing 1200.

The top surface of the filter housing 1200 may be open. A housing top cover 1210 may be disposed on the top surface of the filter housing 1200 to cover the top surface of the filter housing 1200.

The housing top cover 1210 may be concave downward and located under blowing fan 24. The housing top cover 1210 may provide filtered air to the blowing fan 24. For this, the housing top cover 1210 may have a housing top cover opening 1212 penetrated in the vertical direction.

The housing top cover opening 1212 may be located inside of the filter housing 1200. The housing top cover opening 1212 may be disposed within a height of the filter housing 1200. The housing top cover opening 1212 may be under the top surface of the filter housing 1200.

In addition, a top cover grill 1214 may be disposed on the housing top cover opening 1212. A top cover guide 1216 may be formed along an edge of the housing top cover opening.

The top cover guide 1216 may be circular in shape when viewed from a top. The top cover guide 1216 may protrude upwardly and guide the filtered air to the blowing fan 24. The top cover guide 1216 may be inserted onto the blowing fan 24, and resistance of the filtered air flowing to the blowing fan 24 may be minimized.

In this embodiment, the housing top cover opening 1212, the top cover grill 1214, and the top cover guide 1216 are manufactured as one body by injection molding. However, embodiments are not limited thereto.

A part or portion of the side surface of the filter housing 1200 may be open, which is defined as the filter housing opening 1201. The filter housing opening 1201 may be inside the lower cover opening 1341 and be open toward the lower cover opening 1341. The filter 14 may pass through the lower cover opening 1341 and the filter housing opening 1201 in sequence, and then be inserted into the filter housing 1200.

The filter housing 1200 may be inside the lower cover 1340 and be covered by the lower cover 1340. Although the lower cover 1340 is cylindrical shape, the filter housing 1200 may not be cylindrical shape.

The filter housing 1200 may provide an installation structure for installing electronic parts or components of the humidification and air cleaning apparatus. For this, the filter housing 1200 may include a front wall 1220, a left (first lateral) wall 1230, and a right (second lateral) wall 1240. The filter housing opening 1201 may be formed on a rear surface of the filter housing 1200.

When viewed from outside, it is difficult to define a front surface because an overall shape of the humidification and air cleaning apparatus is cylindrical. In this embodiment, the direction of the surface on which the filter housing opening 1201 is formed is defined as the rear, and other directions are defined based on the filter housing opening 1201.

The filter housing 1200 may include the front wall 1220, the left wall 1230, the right wall 1240, a housing upper opening 1202, a housing lower opening 1203, and the filter housing opening 1201. The housing upper opening 1202 may be connected with the front wall 220, the left wall 1230, and the right wall 1240. The housing upper opening 1202 may be positioned above the front wall 1220, the left wall 1230, and the right wall 1240. The housing upper opening 1202 may be circular in shape from a top view. The housing lower opening 1203 may be connected with the front wall 1220, the left wall 1230, and the right wall 1240. The housing lower opening 1203 may be positioned under the front wall 1220, the left wall 1230, and the right wall 1240. The housing lower opening 1203 may be circular in shape from a bottom view. The filter housing opening 1201 may be connected with the left wall 1230 and the right wall 1240. The filter housing opening 1201 may extend toward the lower cover opening 1341 and in which the filter 14 is inserted.

The front wall 1220, the left wall 1230, and the right wall 1240 may be flat. A filter power supply unit 1401 that supplies power to the filter 14 may be disposed on the front wall 1220.

The filter power supply 1401 may be disposed at an opposite side to the filter housing opening 1201. When the filter 14 is completely inserted into the filter housing 1200, the filter power supply unit 1401 and the filter 14 may be electrically connected.

For this, the filter power supply 1401 may be disposed at a front, which is opposite to the filter housing opening 1201. The filter 14 and the filter power supply 1401 may be electrically connected only when the filter 14 contacts the front wall 1220 of the filter housing 1200.

In addition, a speaker 1420 of the voice recognition module 1400 may be disposed on the front wall 1220. The speaker 1420 may be concealed by the lower cover 1340. The speaker 1420 may be disposed to face the front.

A resonant space 1221 may be formed in the front wall 1220 where the speaker 1420 is installed. The resonant space 1221 may be open toward the front.

In order to form the resonant space 1221, a spacer wall 1222 that protrudes forward from the front wall 1220 may be formed. The spacer wall 1222 may have a variety of shapes and a plurality of the spacer wall 1222 may be provided. In this embodiment, the front wall 1220 may be used as a rear wall of the resonant space 1221.

Referring to FIG. 4, the blowing unit 20 may be disposed above the filter housing 1200. An upper surface of the filter housing 1200 may be open. Air after passing through the filter flow path 102 may flow into the blowing unit 20.

The blowing unit 20 induces the flow of air. The blowing unit 20 may be disposed in the base body 110 and induce air to flow from a bottom to a top.

The blowing unit 20 may include a blowing housing 150, a blowing motor 22, and the blowing fan 24. In this embodiment, the blowing motor 22 is disposed above the blowing fan 24. A motor axis of the blowing motor 22 is installed thereunder and assembled with the blowing fan 24.

The blowing housing 150 may be disposed in the base body 110. The blowing housing 150 may provide a flow path for air. The blowing motor 22 and the blowing fan 24 may be disposed in the blowing housing 150.

The blowing housing 150 may be disposed above the filter assembly 10 and under the upper body assembly 120. The blowing housing 150 may form the blowing flow path 108. The blowing fan 24 may be disposed at the blowing flow path 108. The blowing flow path 108 may connect the filter flow path 102 and a cleaning connection flow path 104.

The blowing fan 24 may be a centrifugal fan that suctions air from a lower side and discharges the suctioned air in a radial direction, outward therefrom. The blowing fan 24 may discharge air outwardly in the radial direction and to an upper side. The blowing fan 24 may have an outer end facing a direction between the upward direction and the radial direction.

The blowing motor 22 may be disposed above the blowing fan 24 to minimize contact with flowing air. The blowing fan 24 may surround the blowing motor 22. The blowing motor 22 may not be positioned in the flow path induced by the blowing fan 24, and thus, not generate resistance to the flowing air.

The blowing fan 24 may be disposed above the housing top cover 1210. The blowing fan 24 may be inserted into the housing top cover 1210 which is concave downward.

Referring to FIG. 4, the upper body assembly 120 may include an upper outer body 128, an upper inner body 140, and an air guide 170. The upper outer body 128 may form an outer shape of the base body 110 and be coupled to the lower body assembly 130. The upper inner body 140 may be disposed inside of the upper outer body 128 and provide a connection flow path 103. The water tank 300 may be inserted into the upper inner body 140. The air guide 170 may combine the upper inner body 140 and the upper outer body 128. The air guide 170 may guide air to the water tank 300.

As the upper body assembly 120 separates the connection flow path 103 and a space 125 where the water tank is inserted, it is possible to minimize inflow of water in the water tank 300 into the connection flow path 103. More specifically, as the connection flow path 103 is disposed outside of a space in which the water is stored due to separation by the upper inner body 140, it is possible to prevent water from flowing into the connection flow path 103.

An upper side of the upper inner body 140 may be open and the water tank 300 inserted thereinto. The upper inner body 140 may form a part or portion of the cleaning connection flow path 104 where the filtered air is introduced.

An upper inlet 121, corresponding to an air humidification inlet 31, may be formed in the upper inner body 140. The upper inlet is not the essential element. It is enough that the upper inner body 140 has a shape enabling the upper body assembly 120 to expose the air humidification inlet 31 to the connection flow path 103.

The upper inner body 140 may have a basket shape as a whole. The upper inner body 140 may have a circular shape when viewed from a horizontal cross-section.

A handle 129 may be formed on the upper outer body 128. As the air humidification module 200 may be mounted on the upper body assembly 120, it is possible to lift, as a whole, the humidification and air cleaning apparatus.

The space 125 where the water tank is inserted may be formed in the upper inner body 140. An outer visual body 214 may be coupled to an upper side of the upper body assembly 120.

Although the outer visual body 214 is an element of the visual body 210, in this embodiment, it may be fixed to the upper body assembly 120. Alternatively, the outer visual body 214 may be fixed to the air humidification module 200. Alternatively, the outer visual body 214 may be a removable element.

The outer visual body 214 may be formed of a material through which an inside may be viewed. The outer visual body 214 may be formed of a transparent or translucent material.

A display module 160 that displays an operation state of at least one of the air cleaning module 100 or the air humidification module 200 may be disposed at the outer visual body 214.

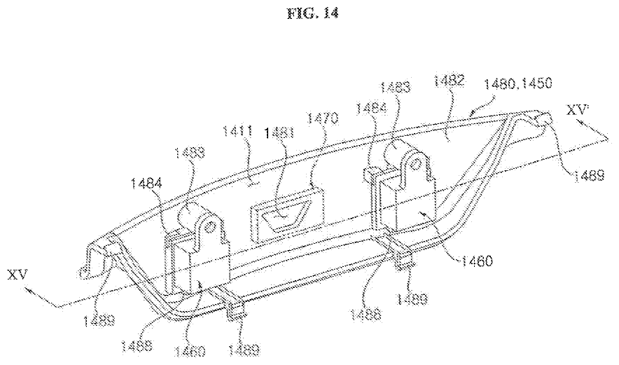

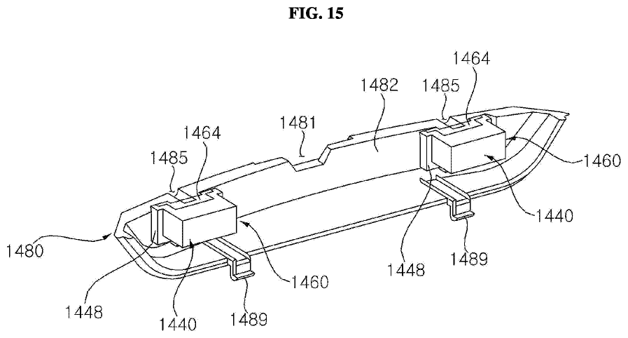

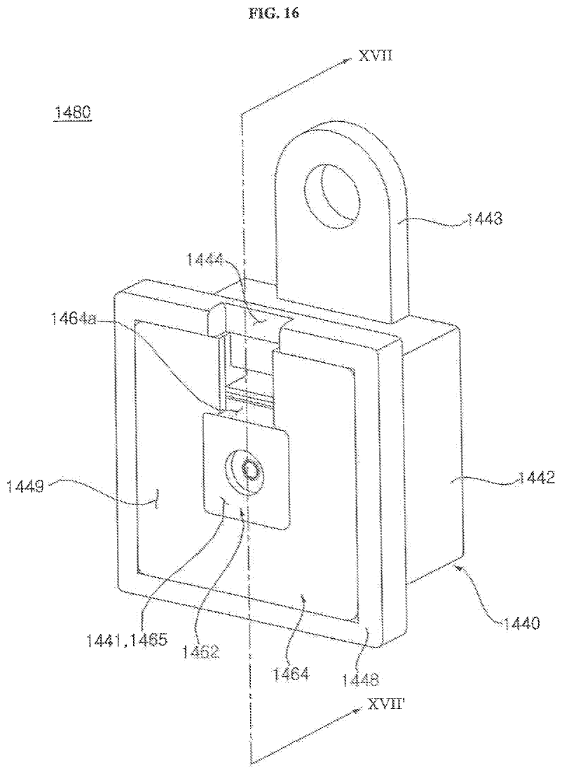

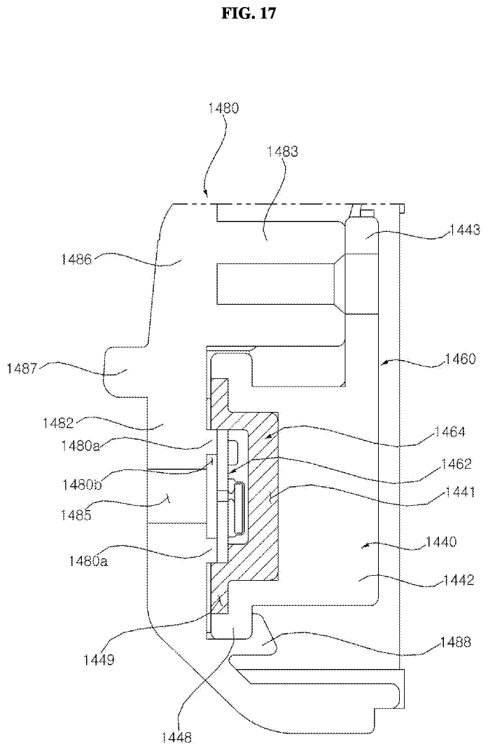

FIG. 14 is a perspective view showing an inside of an input assembly shown in FIG. 1. FIG. 15 is a cross-sectional perspective view, taken along line XV-XV′ of FIG. 14. FIG. 16 is a perspective view of a microphone shown in FIG. 14. FIG. 17 is a cross-sectional view, taken along line XVII-XVII′ shown in FIG. 16.

Referring to FIGS. 5 and 14-17, the voice recognition module 1400 may include the input assembly 1410, the speaker 1420, and a voice recognition control unit (controller) 1430. The input assembly 1410 may be exposed to the outside of the base body 110. The speaker 1420 may be concealed inside of the base body 110. The voice recognition control unit 1430 may be disposed inside of the base body 110 and be electrically connected with the input assembly 1410 and the speaker 1420 and control the input assembly 1410 and the speaker 1420.

The input assembly 1410 may be disposed at the lower body 130 and be exposed to outside of the lower body 130. In this embodiment, the input assembly 1410 is disposed to face the front. Alternatively, the input assembly 1410 may be disposed to face another direction.

The speaker 1420 may be installed in the resonant space 1221 disposed at a front surface of the filter housing 1200. As the resonant space 1221 is open to the front, sound from the speaker 1420 may propagate effectively to the front.

The speaker 1420 may be assembled to the front wall 1220 of the filter housing 1200. Although the speaker 1420 is hidden by the lower cover 1340, the speaker may realize enough volume by the resonant space 1221.

The voice recognition control unit 1430 may be installed at the filter housing 1200. In this embodiment, the voice recognition control unit 1430 is assembled to the right wall 1240 of the filter housing 1200. The voice recognition control unit 1430 may control the speaker 1420 and a microphone 1460 of the input assembly 1410.

The voice recognition control unit 1430 may be electrically connected with the microphone 1460 and the speaker 1420. The voice recognition control unit 1430 may be connected with a voice server 1000 via a fixed-line or wireless network. The voice recognition control unit 1430 may send and receive data with the voice server 1000 via the fixed-line or wireless network.

For example, when the user speaks words containing a wake-up word, for example, “Hi, LG”, the microphone 1460 may send the words containing the wake-up word to the voice recognition control unit 1430, and the voice recognition control unit 1430 may transmit the sent voice signal to the voice server 1000. In this case, the voice recognition control unit 1430 may reduce the noise and sense the wake-up word. The voice recognition control unit 1430 may send natural language to the voice server 1000. The voice server 1000 may process the sent voice data and control the humidification and air cleaning apparatus according to the voice data.

The input assembly 1410 may include the input housing 1450, the microphone 1460, and a remote control sensor 1470. The input housing 1450 may be assembled to the lower housing 1320 and be exposed to outside. The microphone 1460 may be disposed inside of the input housing 1450 and receive sound.

As the microphone 1460 protrudes downward from a bottom of the lower housing 1320, it is possible to minimize the effect of noise. More specifically, as the microphone 1460 is disposed at the suction hole 101 formed between the lower housing 1320 and the lower base 1310, it is possible to minimize the effect of moisture. When water seeps into the microphone 1460, the voice signal of the user may not be received effectively.

As the microphone 1460 is disposed at the suction hole 101, the water may be evaporated rapidly by flowing air. In addition, as the microphone is separated from the humidification unit 400 and the blowing unit 20, it is possible to minimize the effect of operation noise. When the microphone 1460 is disposed near the blowing unit 20, a reception rate may decrease due to operation noise or vibration by rotation of the blowing fan 24. As the microphone 1460 is positioned to protrude below the lower housing 1320, it is possible to minimize the effect of the operation noise and vibration.

The input housing 1450 may be disposed at the lower body assembly 130 and be exposed to an outside of the lower body assembly 130. In this embodiment, the input housing 1450 is disposed to protrude from the bottom of the lower housing 1320. More specifically, the input housing 1450 is assembled to penetrate the voice recognition module installation part 1324. When the input housing 1450 is assembled, it protrudes further downward from the bottom of the lower housing 1320.

The input housing 1450 may be inserted into the lower housing in the direction from the top to the bottom. The input housing 1450 and the stopper 1325 of the lower housing 1320 may be hooked to each other.

In this embodiment, a top surface of the input housing 1450 may be open and other surfaces thereof closed. The open top surface of the input housing 1450 may be referred to as an input housing opening part or portion (opening) 1411. A cable (not shown) connected to the microphone 1460 or the remote control sensor 1470 may pass through the input housing opening part 1411.

The input housing opening part 1411 may communicate with a space between the filter housing 1200 and the lower cover 1340. As the input housing opening part 1411 is disposed on the top surface, the input housing 1450 may include a front housing 1480 disposed to face the front and a rear housing 1490 disposed to face the rear. In this embodiment, the rear housing 1490 and the lower housing 1320 may be produced as one body by injection molding. Alternatively, the rear housing 1490 and the lower housing 1320 may be produced separately and then may be assembled to each other.

The microphone 1460 and the remote control sensor 1470 may be disposed between the front housing 1480 and the rear housing 1490. The front housing 1480 and the rear housing 1490 may be coupled to each other by, for example, fastening or hooking.

The front housing 1480 and the rear housing 1490, coupled to each other, may be assembled to the voice recognition module installation part 1324. The front housing 1480 may provide a surface continuous with the outer surfaces of the lower housing body 1322.

The front housing 1480 may include a front housing body 1482, a remote control reception hole 1481, a microphone fastening part or portion 1483, a microphone supporting part or portion (support) 1484, a microphone reception hole 1485, a front housing lateral surface supporting part or portion (support) 1486, a front housing bottom supporting part or portion (support) 1487, a microphone coupling part or portion 1488 and a housing coupling part or portion 1489. The remote control reception hole 1481 may penetrate the front housing body 1482 in a backward and forward direction. The microphone fastening part 1483 may protrude backward from a rear surface of the front housing body 1482. The microphone fastening part 1483 may fasten and fix the microphone 1460 thereto. The microphone supporting part 1484 may protrude backward from a rear surface of the front housing body 1482. The microphone supporting part 1484 and the microphone 1460 may be in close contact. The microphone supporting part 1484 may support edges of the microphone 1460. The microphone reception hole 1485 may penetrate the front housing body 1482 in backward and forward direction. The front housing lateral surface supporting part 1486 may extend upward from the front housing body 1482. The front housing lateral surface supporting part 1486 may provide a surface continuous with the lower cover lateral surface supporting part 1326. The front housing bottom supporting part 1487 may protrude a forward from the front housing body 1482. The front housing bottom supporting part 1487 may provide a surface continuous with the lower cover bottom supporting part 1327. The microphone coupling part 1488 may protrude backward from a rear surface of the front housing body 1482. The microphone coupling part 1488 may be hooked to the microphone 1460. The housing coupling part 1489 may protrude backward from the front housing body 1482. The housing coupling part 1489 may be coupled to the rear housing 1490.

As the front housing 1480 is not only installed on the lower housing 1320 but also supported by the lower cover 1340, it is possible to reduce vibration caused by operation of the blowing unit 20. More specifically, as the front housing 1480, where the microphone 1460 is installed, is disposed to protrude downward from the bottom of the lower housing 1320, it is possible to block direct transmission, to the microphone 1460, of vibration.

The front housing body 1482 may have a trapezoid shape, with an upper length thereof longer than a lower length thereof, when viewed from the front.

The remote control reception hole 1481 penetrates the front housing 1480 in the backward and forward direction. A transparent window may be disposed at the remote control reception hole 1481. The remote control sensor 1470 may be disposed at a rear of the remote control reception hole 1481. The remote control sensor 1470 may receive an infrared (IR) signal of a remote controller.

The microphone reception hole 1485 may penetrate the front housing 1482 in the backward and forward direction. The microphone reception hole 1485 may face a side opposite to the lower housing suction hole 1321.

One microphone reception hole 1485 may be provided for one microphone 1460. In this embodiment, as there are two microphones 1460, two microphone reception hole 1482 may be provided.

The front housing 1480 may further include a microphone sensor supporting part or portion (support) 1480a. The microphone sensor supporting part 1480a may support a microphone sensor 1462, described hereinafter, and protrude backward from a rear of the front housing body 1482. The microphone sensor supporting part 1480a may be disposed around the microphone reception hole 1485.

The microphone sensor supporting part 1480a may protrude toward the microphone sensor 1462 and form a gap 1480b between the microphone reception hole 1485 and the microphone sensor 1462. A microphone reception hole 1485 may be formed at both left and right side of the microphone reception hole 1481. For ease of explanation, when viewed from the front, the microphone reception hole 1481 disposed at a left side of the remote control reception hole 1481 may be referred to as a “left microphone reception hole”, and the microphone reception hole 1481 disposed at a right side of the remote control reception hole 1481 may be referred to as a right microphone reception hole. Likewise, the microphone disposed at the left side of the remote control sensor 1470 as a “left microphone”, and the microphone disposed at the right side of the remote control sensor 1470 may be referred to as a “right microphone”.

The left microphone and the right microphone may be disposed horizontally. The left microphone, the right microphone, and the remote control sensor 1470 may be arranged in a line.

The microphone 1460 may be installed at a rear of the microphone reception hole 1485. The microphone reception hole 1485 penetrate and be open. The rear of the microphone reception hole 1485 may be closed by contact of the microphone 1460. As the microphone reception hole 1485 is open only forward, it is possible to minimize input, into the microphone 1460, of noise.

The microphone 1460 may be fastened and fixed to the microphone fastening part 1483. The microphone fastening part 1483 may protrude backward from the rear of the front housing body 1482. The microphone fastening part 1483 may be disposed above the microphone 1460. The microphone coupling part 1488 may be disposed under the microphone 1460.

The microphone coupling part 1488 and the microphone 1460 may be hooked to each other and then fastened to each other. As an upper side and a lower side of the microphone 1460 are assembled respectively, the microphone 1460 may have close contact, toward the front housing body 1482, with the front housing body 1482.

The microphone fastening part 1483 and the microphone coupling part 1488 may be disposed opposite to each other with respect to the microphone 1460. Alternatively, the microphone fastening part 1483 and the microphone coupling part 1488 may be disposed on the left and right of the microphone 1460.

The microphone supporting part 1484 may support edges of the microphone 1460 and restrict movement of the microphone 1460. In this embodiment, the microphone supporting part 1484 is a rib that protrudes backward from the rear of the front housing body 1482; however, embodiments are not limited thereto.

The microphone supporting part 1484 may be disposed between the microphone fastening part 1483 and the microphone coupling part 1488. In this embodiment, the microphone supporting part 1484 is disposed under the microphone fastening part 1483 and supports an upper end of the microphone 1460; however, embodiments are not limited thereto.

The microphone supporting part 1484 may support at least two surfaces of the microphone 1460. In this embodiment, the microphone supporting part 1484 supports upper, left, and right surfaces of the microphone 1460.

The microphone 1460 may be hooked to the microphone coupling part 1488 in contact with the microphone supporting part 1484. The microphone supporting part 1484 may provide an assembly position of the microphone 1460.

The housing coupling part 1489 may be for coupling with the rear housing 1490. In this embodiment, the housing coupling part 1489 is hook-coupled to the rear housing 1490. Further, in this embodiment, the housing coupling part 1489 has four places at both side of top and bottom, respectively; however, embodiments are not limited thereto.

Referring to FIGS. 10-12, the input housing 1450 may be disposed at the outer space 101a. The input housing 1450 may be disposed in front of the leg wall 1350. The input housing 1450 and the leg wall 1350 may face each other.

A width, in rightward and leftward directions, of the leg wall 1350 may be longer than a width, in rightward and leftward directions, of the input housing 1450. An area of the leg wall 1350 may be wider than an area of the input housing 1450. A projection, on the leg wall 1350, of the input housing 1450 may be disposed within the area of the leg wall 1350.

The input housing 1450 may be disposed between the first leg 1331 and the second leg 1332. A length between the first leg 1331 and the second leg 1332 may be longer than a length between a left (first) end 1451 and a right (second) end 1452 of the input housing 1450. The left end 1451 and the right end 1452 may be disposed lengthwise between the first leg 1331 and the second leg 1332.

More specifically, the microphone reception hole 1485 may be disposed between the first leg 1331 and the second leg 1332. The microphone reception hole 1485 may be positioned in front of the outer space 101a.

In the outward radial direction, a distance between the first leg 1331 and the second leg 1332 increases. Two microphone reception holes 1485 may be disposed between the first leg 1331 and the second leg 1332.

In this embodiment, an angle between the first leg 1331 and the second leg 1332 is 60 degrees; however, embodiments are not limited thereto.

The outer space 101a may be surrounded by a right surface 1331a of the first leg 1331, the front surface of the leg wall 1350, and a left surface 1332a of the second leg 1332. The input housing 1450 may be positioned in front of the outer space 101a. A voice of the user may be reflected in the leg wall 1350 and may be propagated, by reflection, to the input housing 1450. A structure forming the outer space 101a may reflect, to the microphone reception hole 1485, the voice. The structures may suppress the noise from the lower housing suction hole 1321.

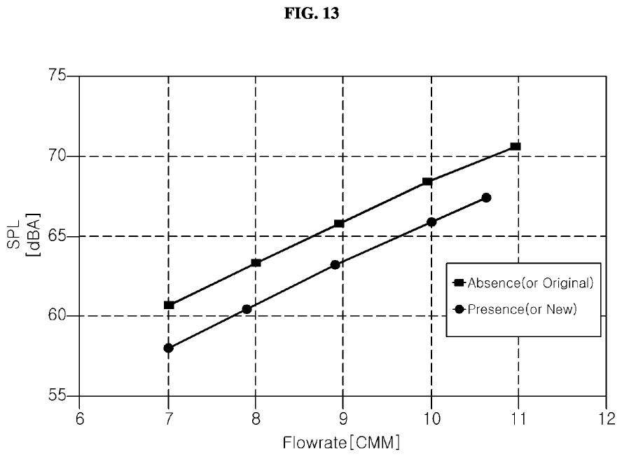

FIG. 13 is a graph showing a magnitude of noise depending on a presence of leg wall 1350. When a flow rate (cmm) increases by rotating the blowing motor 22 more rapidly, noise in the microphone 1460 is sensed. As shown in the graph, when the leg wall 1350 is provided, the noise is reduced by 2.5 dB.

Referring to FIGS. 16, 17, the microphone 1460 may be disposed at a rear of the microphone reception hole 1485. The microphone 1460 may include the microphone sensor 1462, a sealing pad 1464, and a microphone housing 1440. The microphone sensor 1462 may be exposed to the microphone reception hole 1485, a front surface which is formed in the input housing 1450. The sealing pad 1464 may push the microphone sensor 1462 toward the input housing 1450 and cover surfaces excluding the front surface of the microphone sensor 1462. The microphone housing 1440 may be assembled to the input housing 1450 and disposed at a rear of the sealing pad 1464 and push the sealing pad 1464 toward the input housing 1450.

The microphone sensor 1462 may contact the microphone sensor supporting part 1480a protruding from the front housing body 1482. The microphone sensor 1462 may be supported by the microphone sensor supporting part 1480a. So, the microphone sensor 1462 may be spaced apart, by a gap 1480b, from a rear end of the microphone reception hole.

The sealing pad 1464 may cover surfaces excluding the front surface of the microphone sensor 1462. For this, the sealing pad 1464 has an area wider than that of the microphone sensor 1462, and the microphone sensor 1462 is disposed inside of the sealing pad 1464.

A sensor insertion groove 1465, through which the microphone sensor 1462 may pass, may be formed on the sealing pad 1464. The sensor insertion groove 1465 may be formed concavely, to a rear side, on a front surface of the sealing pad 1464.

The sealing pad 1464 may be formed of an elastic material and support the microphone sensor 1462. The sealing pad 1464 may block inflow of foreign substance or moisture into the microphone sensor 1462. The front surface of the sealing pad 1464 may contact the rear surface of the front housing body 1482. The front surface of the sealing pad 1464 and the front surface of the microphone sensor 1462 may be positioned on a same line.

In this embodiment, a cable channel, for wiring of the microphone sensor 1462, may be formed on the sealing pad 1464. A cable may be connected to a rear of the microphone sensor 1462. In this embodiment, the cable is connected to a top of the microphone sensor 1462. For this, the cable channel 1464a, that connects the cable with the microphone sensor 1462, is formed. The cable channel 1464a may be formed by cutting the sealing pad 1464 and disposed at an upper side of the sealing pad 1464. The cable channel 1464a may extend in the vertical direction.

The microphone housing 1440 may include the microphone housing 1440, a microphone housing body 1442, a microphone insertion groove 1441, a microphone housing border 1448, a microphone housing fastening part or portion 1443, and a microphone housing channel 1444. The microphone housing insertion groove 1441 may be formed concavely, to a rear side, in a front surface of the microphone housing body 1442. The microphone housing border 1448 may be disposed at the microphone housing body 1442 and protrude outward from the microphone housing body 1442 and couple to the microphone coupling part 1488 on the front housing 1480. The microphone housing fastening part 1443 may protrude from the microphone housing body 1442 and be fastened to the microphone fastening part 1483 on the front housing 1480. The microphone housing channel 1444, through which the cable of the microphone sensor 1462 may pass, may be formed concavely at the front surface of the microphone housing body 1442.

The microphone housing insertion groove 1441, into which the rear of the sealing pad 1464 may be inserted, may be formed at the microphone housing body 1442. In addition, a pad groove 1449, into which a front of the sealing pad 1464 may be inserted, may be formed at an inner side of the microphone housing border 1448. The pad groove 1449 may be concave rearwardly. The microphone housing border 1448 may contact a rear surface of the front housing 1480.

The pad groove 1449 may be disposed in front of the microphone insertion groove 1441. The microphone sensor 1462 may be inserted into the microphone housing insertion groove 1441.

The microphone housing border 1448 may protrude outward from the microphone housing 1442 and be formed along a border of the microphone housing 1442. Shown from the front, an area of the microphone housing border 1448 may be wider than an area of the microphone housing 1442. The microphone housing border 1448 may have the shape of a rectangular frame when viewed from the front.

The microphone housing channel 1444 may pierce an upper side of the microphone housing border 1448. The microphone housing channel 1444 may be disposed above the cable channel 1464a and be connected with the cable channel 1464a.

As the microphone housing border 1448 protrudes outwardly more than the microphone housing body 1442, the microphone coupling part 1488 may be hooked and fixed to a rear surface of the microphone housing border 1448.

The microphone coupling part 1488 may extend to the rear from the front and support a lower side of the microphone housing border 1448 and be hooked and fixed to the rear surface of the microphone housing border 1448.

The microphone housing fastening part 1443 may protrude upwardly from the microphone housing body 1442. The microphone housing fastening part 1443 may be fastened and fixed to the microphone fastening part 1483. The microphone housing fastening part 1443 may be positioned at a rear of the microphone fastening part 1483.

Hereinabove, although embodiments has been described with reference to exemplary embodiments and the accompanying drawings, the embodiments are not limited thereto, but may be variously modified and altered by those skilled in the art to which the embodiments pertains without departing from the spirit and scope claimed in the following claims.

The humidification and air cleaning apparatus according to embodiments disclosed herein has at least the following advantages.

First, as the input assembly 1410 is exposed to the outside thereof, it is possible to effectively recognize the voice of the user. Second, as the leg wall 1350 is disposed between the input assembly 1410 and the lower housing suction hole 1321, it is possible to suppress noise, propagating to the input assembly 1410, by the blowing unit 20. Third, as the leg wall 1350 and the plurality of legs 1330 form the concave space and the input assembly 1410 is disposed in front of the concave space, it is possible to reflect the voice signal of the user toward the input assembly 1410.

Fourth, as the input assembly 1410 is disposed on the lower housing 1320, disposed far from the humidification unit 400 or the blowing unit 20 which generate the noise, and the input housing 1450 is disposed in the outer space 101a surrounded by the first leg 1331, the second leg 1332, and the leg wall 1350, it is possible to minimize the effect of operating noise. Fifth, as the input assembly 1410, in which the microphone 1460 is disposed, is disposed at an outside of the leg wall 1350, it is possible to minimize the effect of moisture.

Embodiments disclosed herein provide a structure for installation of a voice recognition module of a humidifying and cleaning apparatus recognizing a user's voice effectively. Embodiments disclosed herein further provide a structure for installing a voice recognition module of a humidification cleaning device improving recognition when recognizing a user's voice.

Embodiments disclosed herein provide a structure for installing a voice recognition module of a humidification cleaning device minimizing the effect of operating noise. Embodiments disclosed herein also provide a structure for installing a voice recognition module of a humidifying and cleaning device minimizing the effect of moisture.

Embodiments disclosed herein are not limited to the problems mentioned above, and other problems that are not mentioned will be clearly understood by those who skilled in the art from the following description.

In embodiments disclosed herein, as an input assembly receiving a voice signal is exposed to the outside, a user's voice may be effectively recognized. Further, as the leg wall is disposed between the input assembly and the lower housing inlet, it is possible to suppress propagation of operating noise generated from the blowing unit to the input assembly.

In embodiments disclosed herein, as the leg wall and a plurality of legs form a concave space and the input assembly is disposed in front of the concave space, a user's voice signal may be reflected to the input assembly. As the input assembly is disposed in a lower housing far from the humidification unit or the blowing unit where the operating noise is generated, influence of operating noise may be minimized. Further, in embodiments disclosed herein, as the input assembly in which the microphone is disposed is located outside the leg wall, the influence on moisture may be minimized.

Embodiments disclosed herein provide a humidification and cleaning apparatus that may include a lower base, a lower housing, a plurality of legs, a leg wall, and an input assembly. The lower base may be configured to be supported by the ground. The lower housing may be spaced apart upwardly from the lower base and form a suction gap by being spaced apart from the lower base. The plurality of legs may be disposed on at least one of the lower base or the lower housing. The plurality of legs may support the lower housing. The leg wall may connect two adjacent legs to each other. The input assembly may be disposed at the lower housing. The input assembly may protrude toward the suction gap. The input assembly may receive a wireless signal. The plurality of legs may include a first leg and a second leg adjacent to each other. The input assembly may be disposed outside the leg wall.

Embodiments disclosed herein further include a lower housing suction hole. The lower housing suction hole may be disposed inside the lower housing. The lower housing suction hole may be open in the vertical direction. The leg wall may be disposed between the lower housing suction hole and the input assembly.

As an upper end of the leg wall is coupled to the lower housing and a lower end of the leg wall is coupled to the lower base, the leg wall may seal between the first leg and the second leg. As the leg wall is inclined with respect to the vertical direction and the upper end of the leg wall is disposed outside a lower end of the leg wall, noise propagated from the lower housing suction hole may be effectively reflected.

The input assembly may further include a microphone reception hole through which a voice signal may pass. The microphone reception hole may be disposed within a height of the leg wall.

The lower housing, when viewed from a top, may have a circular shape. The input assembly may be disposed outside the leg wall. The input assembly may be disposed outside the leg wall in a radial direction of the lower housing.

The plurality of legs may be disposed radially, when viewed from a top, with regard to a center of the lower housing. The leg wall may have flat surface.

Embodiments disclosed herein may further include an outer space. The outer space may be open to an outside. The outer space may be surrounded by the first leg, the second leg, and the leg wall. The outer space may be concave inwardly from the outside in a radial direction of the lower housing.

The input assembly may include an input housing and a microphone. A microphone reception hole may be formed at the input housing. The voice signal may pass through the microphone reception hole. The microphone may be disposed at the input housing. The microphone may be exposed partially to an outside through the microphone reception hole.

The input housing may be disposed to face the leg wall. A left or first lateral end and a right or second lateral end of the input housing may be disposed between the first leg and the second leg.

The outer space may be formed which is open outwardly and which is surrounded by the first leg, the second leg, and the leg wall. The outer space may be formed inwardly concave from the outside in a radial direction. The input housing may be disposed at the outside of the outer space.

The plurality of legs may be disposed radially, when viewed from the top, with regard to a center of the lower housing. The outer space may be disposed to expand in the outward radial direction.

The upper end of the leg wall may be coupled to the lower housing. The lower end of the leg wall may be coupled to the lower base. The left end of the leg wall may be coupled to the first leg. The right end of the leg wall may be coupled to the second leg.

Embodiments disclosed herein may further include a lower housing suction hole. The lower housing suction hole may be disposed inside of the lower housing. The lower housing suction hole may be open in the vertical direction. The leg wall may be disposed between the lower housing suction hole and the input housing.

The microphone reception hole may be disposed to face a side opposed to the lower housing suction hole. The lower end of the lower housing may be higher than the lower end of the leg wall and lower than the upper end of the leg.

Embodiments disclosed herein may further include a remote control sensor disposed in the input housing and that receives a remote control signal.

Embodiments disclosed herein are not limited to the effects mentioned above, and other effects that are not mentioned would be clearly understood by those skilled in the art from the description of the claims.

It will be understood that when an element or layer is referred to as being “on” another element or layer, the element or layer can be directly on another element or layer or intervening elements or layers. In contrast, when an element is referred to as being “directly on” another element or layer, there are no intervening elements or layers present. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section could be termed a second element, component, region, layer or section without departing from the teachings of the present invention.

Spatially relative terms, such as “lower”, “upper” and the like, may be used herein for ease of description to describe the relationship of one element or feature to another element(s) or feature(s) as illustrated in the figures. It will be understood that the spatially relative terms are intended to encompass different orientations of the device in use or operation, in addition to the orientation depicted in the figures. For example, if the device in the figures is turned over, elements described as “lower” relative to other elements or features would then be oriented “upper” relative to the other elements or features. Thus, the exemplary term “lower” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments are described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Any reference in this specification to “one embodiment,” “an embodiment,” “example embodiment,” etc., means that a particular feature, structure, or characteristic described in connection with the embodiment is included in at least one embodiment. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A humidification and air cleaning apparatus, comprising:
a lower base configured to be supported by an installation surface;
a lower housing forming a suction gap by being spaced apart upwardly from the lower base;
a plurality of legs disposed on at least one of the lower base or the lower housing and that supports the lower housing;
a leg wall that connects two adjacent legs of the plurality of legs to each other; and
an input assembly disposed at the lower housing, that protrudes toward the suction gap, and receives a wireless signal, wherein the plurality of legs includes a first leg and a second leg adjacent to each other, and wherein the input assembly is disposed at an outside of the leg wall.

2. The humidification and air cleaning apparatus according to claim 1, further comprising:
a lower housing suction hole disposed inside of the lower housing and open in a vertical direction, wherein the leg wall is disposed between the lower housing suction hole and the input assembly.

3. The humidification and air cleaning apparatus according to claim 1, wherein an upper end of the leg wall is coupled to the lower housing, and wherein a lower end of the leg wall is coupled to the lower base.

4. The humidification and air cleaning apparatus according to claim 1, wherein the leg wall is inclined with respect to a vertical direction.

5. The humidification and air cleaning apparatus according to claim 4, wherein an upper end of the leg wall is disposed radially outside of a lower end of the leg wall.

6. The humidification and air cleaning apparatus according to claim 1, wherein the input assembly comprises a microphone reception hole through which a voice signal passes, and wherein the microphone reception hole is disposed within a height of the leg wall.

7. The humidification and air cleaning apparatus according to claim 1, wherein the lower housing, when viewed from a top, has a circular shape, and wherein the input assembly is disposed outside of the leg wall in a radial direction of the lower housing.

8. The humidification and air cleaning apparatus according to claim 1, wherein the plurality of legs is disposed radially outward, when viewed from a top, with regard to a center of the lower housing.

9. The humidification and air cleaning apparatus according to claim 1, wherein the leg wall has flat surface.

10. The humidification and air cleaning apparatus according to claim 1, further comprising:
an outer space open to an outside and surrounded by the first leg, the second leg, and the leg wall, wherein the outer space is concave inwardly from the outside in a radial direction of the lower base.

11. The humidification and air cleaning apparatus according to claim 1, wherein the input assembly comprising:
an input housing in which a microphone reception hole, through which a voice signal passes, is formed;
a microphone disposed at the input housing and exposed partially to an outside through the microphone reception hole.

12. The humidification and air cleaning apparatus according to claim 11, wherein the input housing faces the leg wall.

13. The humidification and air cleaning apparatus according to claim 11, wherein a first lateral end and a second lateral end of the input housing are disposed between the first leg and the second leg.

14. The humidification and air cleaning apparatus according to claim 11, further comprising:
an outer space open to the outside and surrounded by the first leg, the second leg, and the leg wall, wherein the outer space is concave inwardly from the outside in a radial direction of the lower base, and wherein the input housing is disposed at an outside of the outer space.

15. The humidification and air cleaning apparatus according to claim 11, wherein an upper end of the leg wall is coupled to the lower housing, wherein a lower end of the leg wall is coupled to the lower base, wherein a first lateral end of the leg wall is coupled to the first leg, wherein a second lateral end of the leg wall is coupled to the second leg.

16. The humidification and air cleaning apparatus according to claim 11, further comprising:
a lower housing suction hole disposed inside of the lower housing and open in a vertical direction, wherein the leg wall is disposed between the lower housing suction hole and the input housing.

17. The humidification and air cleaning apparatus according to claim 11, wherein a lower end of the lower housing is higher than a lower end of the leg wall and is lower than an upper end of the leg.

18. The humidification and air cleaning apparatus according to claim 11, further comprising:
a remote control sensor disposed in the input housing and configured to receive a remote control signal.

19. A humidification and air cleaning apparatus, comprising:
a lower base configured to be supported by an installation surface;
a lower housing spaced apart upwardly from the lower base and including a lower housing suction hole disposed thereinside and open in a vertical direction;
a plurality of legs extending between the lower base and the lower housing and that supports the lower housing, the plurality of legs including a first leg and a second leg adjacent to each other;
a leg wall that connects the first and second legs to each other; and
an input assembly that protrudes from the lower housing and receives a wireless signal, wherein the leg wall is disposed between the lower housing suction hole and the input assembly.

20. A humidification and air cleaning apparatus, comprising:
a lower base configured to be supported by an installation surface;
a lower housing spaced apart upwardly from the lower base and including a lower housing suction hole disposed thereinside and open in a vertical direction;
a plurality of legs extending between the lower base and the lower housing and that supports the lower housing, the plurality of legs including a first leg and a second leg adjacent to each other;
a leg wall that connects the first and second legs to each other; and
an input assembly that protrudes from the lower housing and receives a wireless signal, wherein the leg wall is inclined with respect to a vertical direction, and wherein the input assembly is disposed at an outside of the leg wall.
